(19) United States
(12) Patent Application Publication
(10) Pub. No.: US 2024/0067809 A1
(43) Pub. Date: Feb. 29, 2024

(54) POLYMER BLENDS HAVING INCREASED TEMPERATURE RESISTANCE

(71) Applicant: DOW GLOBAL TECHNOLOGIES LLC, Midland, MI (US)

(72) Inventors: Santosh S. Bawiskar, Sugarland, TX (US); James R. de Garavilla, Silsbee, TX (US); Jessica Ye Huang, Sugarland, TX (US); Rajesh P. Paradkar, Lake Jackson, TX (US); George Prejean, Orange, TX (US); Kalyan Sehanobish, Sandford, MI (US); Barry A. Morris, Wilmington, DE (US)

(73) Assignee: DOW GLOBAL TECHNOLOGIES LLC, Midland, MI (US)

(21) Appl. No.: 18/254,224

(22) PCT Filed: Nov. 22, 2021
(86) PCT No.: PCT/US2021/060333

§ 371 Date: May 24, 2023

Related U.S. Application Data
(60) Provisional application No. 63/118,202, filed on Nov. 25, 2020.

(51) Int. Cl. C08L 23/08

(52) U.S. Cl. CPC C08L 23/0876; C08L 2201/08; C08L 2205/02; C08L 2207/062

(57) ABSTRACT

Embodiments of polymer blends may include a first polymer composition and a second polymer composition. The first polymer composition may include a polyolefin having a thermal transition temperature of at least 100° C. and a graftable monomer having at least one acid or anhydride functional group grafted onto the polyolefin. The second polymer composition may include an E/X/Y ethylene interpolymer, wherein E is an ethylene monomer and comprises greater than 50 wt. % of the interpolymer, X is an α,β-unsaturated C₃-C₈ carboxylic acid and comprises greater than 0 to 25 wt. % of the interpolymer, and Y is an optional comonomer comprising C₁-C₈ alkyl acrylate.

### TECHNICAL FIELD

The present specification generally relates to polymer blends comprising acid copolymers, ionomers, and combinations thereof, and in particular, polymer blends with enhanced temperature resistance.

### BACKGROUND

Polymer blends comprising acid copolymers and/or ionomers are commonly used materials in various applications, because of their desirable mechanical properties (e.g., notched Izod impact strength), optical properties, or abrasion resistance. For example, these blends may be useful in extruded articles such as films, in foams, and as molded articles. However, these polymer blends may have useful service temperatures lower than 100° C., making them unfit for certain applications that, in use, may near temperatures approaching 100° C. or higher. Accordingly, there is an ongoing need for polymer blends having an increased temperature resistance, as well as desirable impact strength.

### SUMMARY

Embodiments of the present disclosure meet this need for polymer blends having an increased temperature resistance and desirable impact strength.

According to one embodiment, a polymer blend may include a first polymer composition and a second polymer composition. The first polymer composing may include a polyolefin having a thermal transition temperature of at least 100° C. (defined as temperature below which the storage modulus is >10 MPa @ 10 rad/s measured using Dynamic Mechanical Thermal Analysis (DMTA)) and graftable monomer comprising at least one acid or anhydride functional group grafted onto the polyolefin. The second polymer composition may include an E/X/Y ethylene interpolymer, wherein E is an ethylene monomer and comprises greater than 50 weight percent (wt. %) of the interpolymer, X is an α,β-unsaturated C₃-C₈ carboxylic acid and comprises greater than 0 to 25 wt. % of the interpolymer, and Y is an optional comonomer comprising C₁-C₈ alkyl acrylate.

According to another embodiment, an ionomer composition may include the polymer blend, wherein the first polymer composition, the second polymer composition, or both are at least partially neutralized by metal salts.

According to still another embodiment, a method of making the ionomer composition may include blending the first polymer composition and the second polymer composition and neutralizing the first polymer composition and the second polymer composition. The first polymer composition, the second polymer composition, or both may be neutralized by the metal salts before or after blending.

Additional features and advantages will be set forth in the detailed description which follows, and in part will be readily apparent to those skilled in the art from that description or recognized by practicing the embodiments described herein, including the detailed description which follows and the claims.

It is to be understood that both the foregoing general description and the following detailed description describe various embodiments and are intended to provide an overview or framework for understanding the nature and character of the claimed subject matter.

### DETAILED DESCRIPTION

Specific embodiments of the present application will now be described. The disclosure may, however, be embodied in different forms and should not be construed as limited to the embodiments set forth in this disclosure. Rather, these embodiments are provided so that this disclosure will be thorough and complete, and will fully convey the scope of the subject matter to those skilled in the art.

### Definitions

The term “polymer” refers to a polymeric compound prepared by polymerizing monomers, whether of the same or a different type. The generic term polymer thus embraces the term “homopolymer,” usually employed to refer to polymers prepared from only one type of monomer as well as “copolymer” which refers to polymers prepared from two or more different monomers. The term “interpolymer,” as used herein, refers to a polymer prepared by the polymerization of at least two different types of monomers. The generic term interpolymer thus includes copolymers, and polymers prepared from more than two different types of monomers, such as terpolymers.

As used herein, “polyolefin” means any polymer produced from one or more olefins having the formula CₙH₂ₙ. Some ethylene based polymers or propylene based polymers as defined below may be polyolefins; however, ethylene based polymers and propylene based polymer contemplate copolymerization with polar comonomers.

“Polyethylene” or “ethylene based polymer” shall mean polymers comprising greater than 50% by weight of units which have been derived from ethylene monomer. This includes polyethylene homopolymers or copolymers (meaning units derived from two or more comonomers). Comonomers may include olefin comonomers as well as polar comonomers. Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

The term “LDPE” may also be referred to as “high pressure ethylene polymer” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 grams per cubic centimeter (g/cc) to 0.935 g/cc.

The term “LLDPE”, includes resin made using Ziegler-Natta catalyst systems as well as resin made using single-site catalysts, including, but not limited to, bis-metallocene catalysts (sometimes referred to as “m-LLDPE”) and constrained geometry catalysts, and resin made using post-metallocene, molecular catalysts. LLDPE includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or U.S. Pat. No. 5,854,045). The LLDPE resins can be made via gas-phase, solution-phase or slurry polymerization or any combination thereof, using any type of reactor or reactor configuration known in the art.

The term “MDPE” refers to polyethylenes having densities from 0.926 to 0.940 g/cc. “MDPE” is typically made using chromium or Ziegler-Natta catalysts or using single-site catalysts including, but not limited to, bis-metallocene catalysts and constrained geometry catalysts.

The term “HDPE” refers to polyethylenes having densities greater than about 0.940 g/cc, which are generally prepared with Ziegler-Natta catalysts, chrome catalysts or single-site catalysts including, but not limited to, bis-metallocene catalysts and constrained geometry catalysts.

The term “propylene-based polymer” or “polypropylene” as used herein, refers to a polymer that comprises, in polymerized form, refers to polymers comprising greater than 50% by weight of units which have been derived from propylene monomer. This includes propylene homopolymer, random copolymer polypropylene, impact copolymer polypropylene, propylene/α-olefin interpolymer, and propylene/α-olefin copolymer. Comonomers may include olefin comonomers as well as polar comonomers.

As used in the present disclosure, the terms “blend” or “polymer blend,” as used, refer to a mixture of two or more polymers. A blend may or may not be miscible (phase separated at the molecular level). A blend may or may not be phase separated. A blend may or may not contain one or more domain configurations, as determined from transmission electron spectroscopy, light scattering, x-ray scattering, and other methods known in the art. The blend may be prepared by physically mixing the two or more polymers on the macro level (for example, melt blending resins or compounding) or the micro level (for example, simultaneous forming within the same reactor). It is possible to prepare the blends in a melt phase or using solution blending in a common solvent.

As used in the present disclosure, the term “ionomer” refers to a polymer that comprises repeat units of both electrically neutral repeating units and a fraction of ionized units covalently bonded to the polymer backbone as pendant moieties.

As used herein, “graftable monomer” means a molecule connected (e.g., chemically bonded) to the polymer as a side chain, but not polymerized or copolymerized as part of the main polymer chain.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

Polymer blends of the present disclosure may include a first polymer and a second polymer. It is contemplated that the polymer blends of the present disclosure may include any number of additional polymers, such as a third polymer, a fourth polymer, a fifth polymer, or a sixth polymer. One skilled in the art will appreciate that the polymer blends of the present disclosure may be prepared using any conventional or yet-to-be be developed method or technique.

The first polymer composition of the polymer blends of the present disclosure may include a polyolefin having a thermal transition temperature of at least 100° C. As used in the present disclosure, the thermal transition temperature may be defined as the temperature below which the storage modulus is >10 MPa @ 10 rad/s measured using Dynamic Mechanical Thermal Analysis (DMTA). In embodiments, the thermal transition temperature of the polyolefin may be at least 105° C., such as at least 110° C., at least 115° C., at least 120° C., or at least 125° C.

As stated previously, the polyolefin of the first polymer composition of the polymer blends of the present disclosure may comprise an ethylene based polymer or a propylene based polymer.

In embodiments where the polyolefin of the first polymer composition of the polymer blends of the present disclosure may comprise an ethylene based polymer, the ethylene based polymer may include high-density polyethylene (HDPE). In one or more embodiments, the HDPE may have a density from 0.940 g/c to 0.980 g/cc, or from 0.945 g/cc to 0.965 g/cc, or from 0.945 g/cc to 0.955 g/cc. In alternative embodiments, the ethylene based polymer may comprise a linear low density polyethylene (LLDPE) or a low density polyethylene (LDPE).

The polyolefin of the first polymer composition of the polymer blends of the present disclosure may have a melt index (I₂) of from 0.5 g/10 mins to 300 g/10 mins. For example, the polyolefin of the first polymer composition of the polymer blends of the present disclosure may have a melt index (I₂) of from 0.5 to 275 g/10 mins, such as from 0.5 g/10 mins to 250 g/10 mins, from 0.5 g/10 mins to 225 g/10 mins, from 0.5 g/10 mins to 200 g/10 mins, from 0.5 to 175 g/10 mins, such as from 0.5 g/10 mins to 150 g/10 mins, from 0.5 g/10 mins to 125 g/10 mins, from 0.5 g/10 mins to 100 g/10 mins, from 0.5 to 75 g/10 mins, such as from 0.5 g/10 mins to 50 g/10 mins, from 0.5 g/10 mins to 25 g/10 mins, from 0.5 g/10 mins to 10 g/10 mins, from 2.5 g/10 mins to 300 g/10 mins, from 2.5 to 275 g/10 mins, such as from 2.5 g/10 mins to 250 g/10 mins, from 2.5 g/10 mins to 225 g/10 mins, from 2.5 g/10 mins to 200 g/10 mins, from 2.5 to 175 g/10 mins, such as from 2.5 g/10 mins to 150 g/10 mins, from 2.5 g/10 mins to 125 g/10 mins, from 2.5 g/10 mins to 100 g/10 mins, from 2.5 to 75 g/10 mins, such as from 2.5 g/10 mins to 50 g/10 mins, from 2.5 g/10 mins to 25 g/10 mins, from 2.5 g/10 mins to 10 g/10 mins. The polyolefin of the first polymer composition of the polymer blends may have a melt index (I₂) of from 0.5 g/10 mins to 60 g/10 mins, 0.5 g/10 mins to 50 g/10 mins, of 0.5 g/10 mins to 40 g/10 mins, of 0.5 g/10 mins to 30 g/10 mins, of 0.5 g/10 mins to 20 g/10 mins, of 0.5 g/10 mins to 10 g/10 mins, of 1.0 g/10 mins to 60 g/10 mins of 1.0 g/10 mins to 50 g/10 mins, of 1.0 g/10 mins to 40 g/10 mins, of 1.0 g/10 mins to 30 g/10 mins, of 1.0 g/10 mins to 20 g/10 mins, of 1.0 g/10 mins to 10 g/10 mins, of 1.5 g/10 mins to 60 g/10 mins of 1.5 g/10 mins to 50 g/10 mins, of 1.5 g/10 mins to 40 g/10 mins, of 1.5 g/10 mins to 30 g/10 mins, of 1.5 g/10 mins to 20 g/10 mins, or of 1.5 g/10 mins to 10 g/10 mins.

The first polymer composition of the polymer blends of the present disclosure includes a graftable monomer comprising at least one acid or anhydride functional group grafted onto the polyolefin. Of particular interest are graftable monomers having both a vinyl unsaturation and an acid or anhydride group. The graftable monomers may be grafted onto the polyolefin using free radical initiators which generate free radicals. Graft polymerization reaction may be conducted in the presence of a free radical generator such as an organic peroxide (e.g., alkyl peroxides) or an azo compound. Ultrasound or ultraviolet irradiation or by any high energy radiation can be used to generate free radicals. The graftable monomer may, alternatively or additionally, be grafted onto the polyolefin using thermal grafting. Thermal grafting may refer to grafting accomplished using shear and heat using an extruder or a high shear mixer. The graft level of the graftable monomer may be from 0.1 wt. % to 20 wt. % of the combined weight of the polyolefin and the graftable monomer. In embodiments, the graft level of the graftable monomer may be from 0.3 wt. % to 10 wt. % or from 0.5 wt. % to 8 wt. %. Moreover, the graft polymerization process may also use a coagent which aids in grafting the polyolefin and graftable monomer. Various coagents with high levels of unsaturation are considered suitable, for example, allyl, vinyl, or acrylate coagents.

The graftable monomer may include acrylic acid, methacrylic acid, ethacrylic acid, itaconic acid, maleic acid, fumaric acid, monoesters of said dicarboxylic acids, such as methyl hydrogen maleate, methyl hydrogen fumarate, ethyl hydrogen fumarate, maleic anhydride, or combinations thereof. In specific embodiments, the graftable monomer may include acrylic acid or methacrylic acid. In embodiments, the graftable monomer may comprise, consist, or consist essentially of at least one of acrylic acid, methacrylic acid, or both grafted onto the polyolefin.

The second polymer composition of the polymer blends of the present disclosure may include an E/X/Y ethylene interpolymer. The “E” of the E/X/Y ethylene interpolymer may be an ethylene monomer. The ethylene monomer may comprise greater than 50 wt. % of the interpolymer. The “X” of the E/X/Y ethylene interpolymer may be an α,β-unsaturated C₃-C₈ carboxylic acid. The α,β-unsaturated C₃-C₈ carboxylic acid may comprise greater than 0 to 25 wt. % of the ethylene interpolymer or from 1 to 10 wt. % of the ethylene interpolymer. Examples of “X” may include acrylic acid, methacrylic acid, ethacrylic acid, itaconic acid, maleic acid, fumaric acid, monoesters of said dicarboxylic acids, such as methyl hydrogen maleate, methyl hydrogen fumarate, ethyl hydrogen fumarate and maleic anhydride. In specific embodiments, the “X” comprises acrylic acid or methacrylic acid.

The “Y” of the E/X/Y ethylene interpolymer may be an optional comonomer comprising C₁-C₈ alkyl acrylate. These may include but are not limited to ethyl acrylate, methyl acrylate, n-butyl acrylate, iso-butyl acrylate, or combinations of these.

The second polymer composition of the polymer blends of the present disclosure may have a density from 0.910 g/cc to 0.990 g/cc, or from 0.920 g/cc to 0.980 g/cc, or from 0.925 g/cc to 0.975 g/cc.

The second polymer composition of the polymer blends of the present disclosure may have a melt index (I₂) of from 0.5 g/10 mins to 500 g/10 mins. For example, the second polymer composition of the polymer blends of the present disclosure may have a melt index (I₂) of from 0.5 to 475 g/10 mins, such as from 0.5 g/10 mins to 450 g/10 mins, from 0.5 g/10 mins to 425 g/10 mins, from 0.5 g/10 mins to 400 g/10 mins, from 0.5 to 375 g/10 mins, such as from 0.5 g/10 mins to 350 g/10 mins, from 0.5 g/10 mins to 325 g/10 mins, from 0.5 g/10 mins to 300 g/10 mins, from 0.5 to 275 g/10 mins, such as from 0.5 g/10 mins to 250 g/10 mins, from 0.5 g/10 mins to 225 g/10 mins, from 0.5 g/10 mins to 200 g/10 mins, from 0.5 to 175 g/10 mins, such as from 0.5 g/10 mins to 150 g/10 mins, from 0.5 g/10 mins to 125 g/10 mins, from 0.5 g/10 mins to 100 g/10 mins, from 0.5 to 75 g/10 mins, such as from 0.5 g/10 mins to 50 g/10 mins, from 0.5 g/10 mins to 25 g/10 mins, from 0.5 g/10 mins to 10 g/10 mins, from 2.5 g/10 mins to 450 g/10 mins, from 2.5 g/10 mins to 425 g/10 mins, from 2.5 g/10 mins to 400 g/10 mins, from 2.5 to 375 g/10 mins, such as from 2.5 g/10 mins to 350 g/10 mins, from 2.5 g/10 mins to 325 g/10 mins, from 2.5 g/10 mins to 300 g/10 mins, from 2.5 to 275 g/10 mins, such as from 2.5 g/10 mins to 250 g/10 mins, from 2.5 g/10 mins to 225 g/10 mins, from 2.5 g/10 mins to 200 g/10 mins, from 2.5 to 175 g/10 mins, such as from 2.5 g/10 mins to 150 g/10 mins, from 2.5 g/10 mins to 125 g/10 mins, from 2.5 g/10 mins to 100 g/10 mins, from 2.5 to 75 g/10 mins, such as from 2.5 g/10 mins to 50 g/10 mins, from 2.5 g/10 mins to 25 g/10 mins, from 2.5 g/10 mins to 10 g/10 mins. The second polymer composition of the polymer blends may have a melt index (I₂) of from 0.5 g/10 mins to 50 g/10 mins, of 0.5 g/10 mins to 40 g/10 mins, of 0.5 g/10 mins to 30 g/10 mins, of 0.5 g/10 mins to 20 g/10 mins, of 0.5 g/10 mins to 10 g/10 mins, of 1.0 g/10 mins to 60 g/10 mins of 1.0 g/10 mins to 50 g/10 mins, of 1.0 g/10 mins to 40 g/10 mins, of 1.0 g/10 mins to 30 g/10 mins, of 1.0 g/10 mins to 20 g/10 mins, of 1.0 g/10 mins to 10 g/10 mins, of 1.5 g/10 mins to 60 g/10 mins of 1.5 g/10 mins to 50 g/10 mins, of 1.5 g/10 mins to 40 g/10 mins, of 1.5 g/10 mins to 30 g/10 mins, of 1.5 g/10 mins to 20 g/10 mins, or of 1.5 g/10 mins to 10 g/10 mins.

The polymer blends of the present disclosure may include a weight ratio of the first polymer composition to the second polymer composition ranging from 20/80 wt. % to 80/20 wt. %. For example polymer blends of the present disclosure may include a weight ratio of the first polymer composition to the second polymer composition ranging from 25/75 wt. % to 75/25 wt. %, such as from 30/70 wt. % to 70/30 wt. %, from 35/65 wt. % to 65/35 wt. %, from 40/60 wt. % to 60/40 wt. %, or from 45/55 wt. % to 55/45 wt. %.

The polymer blends of the present disclosure may also be formed as an ionomer composition. In such an embodiment, the first polymer composition, the second polymer composition, or both of the polymers in the blend are at least partially neutralized by metal salts used as a source of ions. Typical ion sources include sodium hydroxide, sodium carbonate, sodium acetate, zinc oxide, zinc acetate, magnesium hydroxide, and lithium hydroxide. Other ion sources are well known and will be appreciated by those skilled in the art. In addition to the sodium, zinc, magnesium, and lithium ions, other alkali metal or alkaline earth metal cations are useful and may include potassium, calcium, tin, lead, aluminum, and barium. A combination of ions may also be used. It is contemplated that the first polymer composition, the second polymer composition, or both of the polymers in the blend may be at last partially neutralized by metal salts with or without a catalyst. Catalysts such as water or acetic acid may be used. The polymer blend in the ionomer composition may have any feature or composition as previously described in the present disclosure with reference to the polymer blend.

It is contemplated that the degree of neutralization may be dependent on the desired application. As used in the present disclosure, the “degree of neutralization” may refer to the amount of acid sites that are neutralized by a metal salt. The degree of neutralization may be based on the amount of acid sites on the first polymer composition, the second polymer composition, or both. In embodiments, the degree of neutralization of the first polymer composition, the second polymer composition, or both may be from 15% to 90%. That is, from 15% to 90% of acid sites of the first polymer composition, the second polymer composition, or both may be neutralized by the metal salts.

In embodiments, from 15% to 90% of acid sites of the first polymer composition, the second polymer composition, or both may be neutralized by the metal salts, such as from 15% to 80%, from 15% to 70%, from 15% to 60%, from 15% to 50%, from 15% to 40%, from 15% to 30%, from 15% to 20%, from 25% to 90%, from 25% to 80%, from 25% to 70%, from 25% to 60%, from 25% to 50%, from 25% to 40%, from 25% to 30%, from 35% to 90%, from 35% to 80%, from 35% to 70%, from 35% to 60%, from 35% to 50%, from 35% to 40%, from 45% to 90%, from 45% to 80%, from 45% to 70%, from 45% to 60%, from 45% to 50%, from 55% to 90%, from 55% to 80%, from 55% to 70%, from 55% to 60%, from 65% to 90%, from 65% to 80%, from 65% to 70%, from 75% to 90%, from 75% to 80%, or from 85% to 90%,

The ionomer compositions of the present disclosure may be defined by a rheology ratio greater than 10.0. As used in the present disclosure, “rheology ratio” may refer to the ratio of the viscosity measured at a shear rate of 0.1 s⁻¹ and 190° C. to the viscosity measured at 100 s⁻¹ and 190° C. In embodiments, the ionomer composition may have a rheology ratio may be greater than 10.5, such as greater than 11.0, greater than 11.5, greater than 12.0, greater than 12.5, greater than 13.0, greater than 13.5, greater than 14.0, greater than 14.5, or greater than 15.0. Without being bound by theory, a rheology ratio of greater than 10.0 correlates to improved processability of the polymer and/or polymer blend.

The ionomer compositions of the present disclosure may have a phase angle less than 57° measured at 190° C. and at complex modulus, G*=20 kPa, using dynamic rheological measurements, such as oscillatory shear measurements. As used in the present disclosure, “phase angle” is a measurement of the relationship of stress and strain, which is a function of how much the ionomer composition response lags behind the strain input. For a Newtonian liquid, the phase angle will be 90 degrees and for Hookean solid it will be 0 degrees. The phase angle of viscoelastic material (i.e., the polymer, polymer blend, ionomer, or ionomer composition of the present disclosure) falls in between these two extremes. In embodiments, the ionomer composition may have a phase angle less than 56°, such as less than 55°, less than 54°, less than 53°, less than 52°, less than 51°, or less than 50°. Again, without being bound by theory, a phase angle of less than 57° correlates to improved processability of the polymer and/or polymer blend.

The polymer blends and ionomer compositions of the present disclosure may have a thermal transition temperature measured using dynamic mechanical thermal analysis (DMTA), which is explained in detail in the Test Methods section of the present disclosure, of greater than 90° C., such as greater than 92° C., greater than 94° C., greater than 96° C., greater than 98° C., greater than 100° C., greater than 102° C., greater than 104° C., greater than 106° C., greater than 108° C., or greater than 110° C.

The polymer blends and ionomer compositions can additionally include small amounts of additives including plasticizers, stabilizers including viscosity stabilizers, hydrolytic stabilizers, primary and secondary antioxidants, ultraviolet light absorbers, anti-static agents, dyes, pigments or other coloring agents, inorganic fillers, fire-retardants, lubricants, reinforcing agents such as glass fiber and flakes, synthetic (for example, aramid) fiber or pulp, foaming or blowing agents, processing aids, slip additives, antiblock agents such as silica or talc, release agents, tackifying resins, or combinations of two or more thereof. Inorganic fillers, such as calcium carbonate, and the like can also be incorporated into the polymer blends and ionomer compositions.

These additives may be present in the polymer blends and ionomer compositions in quantities ranging from 0.01 wt. % to 40 wt. %, 0.01 to 25 wt. %, 0.01 to 15 wt. %, 0.01 to 10 wt. %, or 0.01 to 5 wt. %. The incorporation of the additives can be carried out by any known process such as, for example, by dry blending, by extruding a mixture of the various constituents, by the conventional masterbatch technique, or the like.

A method of making the polymer blends of the present disclosure may include blending the first polymer composition and the second polymer composition. Similarly, a method of making the ionomer compositions of the present disclosure may include blending the first polymer composition and the second polymer composition and neutralizing the first polymer composition and the second polymer composition. When neutralizing the first polymer composition and the second polymer composition, the first polymer composition, the second polymer composition, or both may be neutralized by the metal salts before or after blending.

The method of making the polymer blends or ionomer compositions of the present disclosure, that is the blending and neutralizing steps, may be carried out in a continuous process. In embodiments where the blending and neutralizing steps are carried out in a continuous process, the components may be blended and neutralized using an extruder or a kneader. Some examples of continuous equipment that can be used include co-rotating or counter-rotating twin screw extruders, single screw extruders, continuous mixers, reciprocating kneaders, and multi screw extruders. The method of making the polymer blends or ionomer compositions of the present disclosure may alternatively be carried out in a batch process. In embodiments where the blending and neutralizing steps are carried out in a batch process, the components may be blended and neutralized using a batch mixer. Some examples of batch mixers are a two-roll mill, intermeshing, or non-intermeshing internal mixers.

According to various embodiments, the polymer blends or ionomer compositions of the present disclosure may be used to form an extruded article such as a blown or cast film, a foam, or a molded article. For example, in embodiments where the polymer blends or ionomer compositions may be used to form a foam, the polymer blends or ionomer compositions can be combined with additives used to control foam properties to form foams of various shapes. In some embodiments, the foam may be extruded, such as from a twin screw extruder, as is known to those of ordinary skill in the art.

### Test Methods

Density

Samples for density measurement are prepared according to ASTM D 1928. Polymer samples are pressed at 190° C. and 30,000 psi for three minutes, and then at 21° C. and 207 MPa for one minute. Measurements are made within one hour of sample pressing using ASTM D792, Method B.

Melt Index (I₂)

Melt index, or I₂, (grams/10 minutes or dg/min) is measured in accordance with ASTM D 1238, Condition 190° C./2.16 kg, Procedure B.

Dynamic Mechanical Spectroscopy (DMS)

Small angle (amplitude) oscillatory shear measurements were performed using a TA Instruments ARES, equipped with 25 mm parallel plates under a nitrogen purge. The experiments were performed at 190° C., over a frequency range of 0.1 s⁻¹ to 100 s⁻¹. The strain amplitude was adjusted, based upon the response of the samples from 1% to 3%. The stress response was analyzed in terms of amplitude and phase, from which, the storage modulus (G′), loss modulus (G″), complex modulus (G*), dynamic viscosity η*, phase angle (δ) were measured as a function of frequency. The ratio of shear viscosity at shear rates of 0.1 s⁻¹ and 100 s⁻¹ was used to calculate the rheology ratio. The phase angle δ at a complex modulus G* of 20 kPa was also recorded. The rheology ratio and 8 were used as a measure of melt elasticity and melt strength. Samples were dried at 70° C.-80° C. overnight prior to testing.

Dynamic Mechanical Thermal Analysis (DMTA)

DMTA measurements were performed on an ARES-G2 instrument under a nitrogen purge. Samples of about 3 mm thickness were die cut to a rectangular specimen of 12.7 mm×30 mm dimension. A temperature sweep was performed in the torsional mode from 30° C. to 140° C. in 5° C. increments. A frequency of 10 rad/s was used. The strain amplitude was adjusted (from 0.1% to 5%) to control the torque response. The storage modulus was measured as a function of temperature and the temperature at which the storage modulus (G′) dropped below 10 MPa was used a measure of temperature resistance and termed the thermal transition temperature. Samples were dried at 70° C.-80° C. for 8 to 10 hours prior to testing.

Neutralization Levels

The % neutralization levels were calculated based on the moles of neutralizing agent used in the formulation in relation the moles of acid present (either grafted or part of the base acid copolymer) and also accounting for the valence of the ion.

The percent neutralization of an ionomer resin can be readily calculated on a stoichiometric basis. For example, the ratio of the combined base metal cation(s) on a percent molar basis to the combined acid-moieties of the acid copolymer(s) on a percent molar basis is percent neutralization. Terms such as percent neutralization can be used interchangeably with terms such as percent neutralized and degree of neutralization. There may be a plurality of acid moiety types present in the polymer or polymer blends as well as a plurality of cation types present used to neutralize the acid moieties. As such, the formula for neutralization can be expressed as:

$$\% Neutralization = 100 \times \frac{\sum [ \frac{( \% {NA}_{A} X F a c t o {r}_{A} )}{M {W}_{A}} ] + [ \frac{( \% {NA}_{B} X F a c t o {r}_{B} )}{M {W}_{B}} ] + …}{\sum [ \frac{( \% {ACID}_{a} )}{M {W}_{a}} ] + [ \frac{\% {ACID}_{b} )}{M {W}_{b}} ] + …}$$

In the above formula, % NA_{J} is the weight percent of the neutralizing agent J, MW_{J} is the molecular weight of the neutralizing agent J, % ACIDₐ is the weight percent of the acid copolymer or graft a and MWₐ is the molecular weight of the acid type. The molecular weight of acrylic acid is 72.06 g/mol, that of methacrylic acid is 86.09 g/mol, that of zinc oxide is 81.41 g/mol and that of sodium carbonate is 105.99. The Z symbol indicates summation over the different ion species in the numerator and the different acid species in the denominator. The Factors is the product of the valence and the number of atoms of the ion in the molecular formula of the neutralizing agent J. For example, in zinc oxide (ZnO), each zinc atom has a valence of two and there is one zinc atom in ZnO. Therefore, the Factor_{ZnO} is 2. For example, in sodium carbonate (Na₂CO₃), each sodium atom has a valence of one and there are two sodium atoms in Na₂CO₃. Therefore, the Factor_{Na2CO3} is also 2.

The amount of basic metal compounds capable of achieving a target neutralizing of the acid moieties groups in the acid copolymer may be determined by adding the stoichiometric amount of the basic compound calculated to neutralize a target amount of acid moieties in the acid copolymer.

Notched Izod Impact Strength

Notched Izod impact strength testing was performed according to ASTM D256 on samples cut out of injection molded plaques. Testing was conducted at three different temperatures: 23° C., 0° C. and −23° C.

### EXAMPLES

Embodiments will be further clarified by the following examples.

The following examples were prepared using various components. Table 1 sets forth the trade names of those components and the properties of those components. The materials used, their properties and their suppliers are summarized in the table below. The zinc oxide (ZnO) and the sodium carbonate (Na₂CO₃) masterbatch were prepared in a twin screw extruder and were in a pellet form to enable ease of handling and feeding in subsequent steps.

TABLE 1
Example Components and Properties

| | | | Melting | Melt | |
|---|---|---|---|---|---|
| | | Density¹, | Temp.¹, | Index^{1,2}, | |
| Designation | Composition | g/cc | ° C. | g/10 min | Manufacturer |
| Polybond 1009 | Acrylic Acid (AA) grafted HDPE, | 0.95 | 127 | 5 | SI Group |
| | 5.5-6.5 wt. % AA | | | | |
| DMDA 8007 | HDPE | 0.96 | 132 | 8.5 | Dow Inc. |
| SURLYN ™ | Zinc Based Ionomer based on | 0.97 | 86 | 0.7 | Dow Inc. |
| 9910 | ethylene acid copolymer | | | | |
| SURLYN ™ | Sodium based Ionomer based on | 0.95 | 95 | 2.5 | Dow Inc. |
| 1605 | ethylene acid copolymer | | | | |
| NUCREL ™ | Ethylene Acrylic Acid Copolymer, 7 | 0.93 | 102 | 7 | Dow Inc. |
| 30707 | wt. % AA | | | | |
| NUCREL ™ | Ethylene Methacrylic Acid (MAA) | 0.93 | 100 | 10 | Dow Inc. |
| 0910 | Copolymer, 8.7 wt. % MAA | | | | |
| ZnO³ MB | 45 wt. % zinc oxide masterbatch in an | — | — | — | — |
| | ethylene acrylic acid copolymer | | | | |
| | carrier | | | | |
| Na₂CO₃⁴ MB | 55 wt. % sodium carbonate | — | — | — | — |
| | masterbatch in an ethylene acrylic | | | | |
| | acid copolymer carrier | | | | |

¹From Manufacturer's Technical Data Sheet
²@ 190° C., 2.16 kg
³Grade 77HSA from US Zinc
⁴Grade Sodium Acetate Anhydrous from Brenntag North America

### Comparative Example 1—Polymer Blends

In Comparative Example 1, polymer blends including HDPE without a grafted monomer were prepared. Table 2 provides the composition of these comparative polymer blends and their resulting properties.

The components of the examples of Table 2 were mixed in a twin screw extruder. Specifically, the polymers, polymer blends, ionomers, and ionomer blends were prepared on a Coperion ZSK 26 co-rotating twin screw extruder (TSE) with a 60 LD ratio. The motor was rated at 40 horsepower, and the maximum screw speed was 1,200 RPM. The feed rate was 8 lbs/hr and the screw speed used was 250 rpm. Barrel temperatures were maintained at 180° C.-200° C. Deionized water was injected using a high pressure piston pump in some experiments. A 20 in Hg vacuum was pulled after mixing and prior to the die to remove by-products upon neutralization (water). The compounded material was extruded through a two hole die into a 10 foot long chilled water bath. The strands were then passed through an air knife to remove excess water and were cut into pellets using a strand cutter.

The compounded pellets were injection molded into plaques. Specifically, 4″×6″×0.125″ plaques were formed using a Toyo Si-90 injection molding machine. All materials were dried for 4 hours at 70° C. prior to molding. Barrel temperatures of 170° C.-210° C. were used. A shot size of 125 mm, injection speed of 75 mm/s, and plasticizing screw speed of 75-100 rpm was used. The injection molded plaques were used to cut specimens for DMS and DMTA testing.

As shown, the Table 2 blends with DMDA 8007, an HDPE without a grafted monomer, achieves a thermal transition DMTA temperature above 100° C., but fails to achieve the rheology ratio above 10 and also fails to achieve a phase angle less than 57°, which are properties that are indicative of improved processability.

TABLE 2
Polymer Blend Compositions and Properties

| | Comp. | Comp. | Comp. |
|---|---|---|---|
| | Ex. 1A | Ex. 1B | Ex. 1C |
| DMDA 8007 | 50 | 50 | 50 |
| SURLYN ™ 1605 | — | — | 50 |
| SURLYN ™ 9910 | 50 | — | — |
| NUCREL ™ 30707 | — | 50 | — |

Dynamic Mechanical Spectrometry (DMS) & DMTA Data

| | | | |
|---|---|---|---|
| Viscosity @ 0.1 s⁻¹, 190° C. | 5793 | 2424 | 3242 |
| Viscosity @ 100 s⁻¹, 190° C. | 796 | 411 | 568 |
| Rheology Ratio | 7.3 | 5.9 | 5.7 |
| Phase Angle @ G* = 20 kPa, 190° C. | 59 | 70 | 71 |
| Thermal Transition DMTA | 122 | 117 | 122 |
| Temperature @ G′ = 10 MPa, 10 rad/s | | | |

### Example 2—Ionomer Compositions with Enhanced Temperature Resistance Neutralized Using Zinc Salts

In Example 2, further blends were prepared using the same method of Comparative Example 1. As opposed to Example 1, these first polymer composition of these polymer blends were grafted with a graftable monomer comprising at least one acid or anhydride functional group and then at least partially neutralized using a zinc salt. Table 3 provides the composition of the various ionomer blends neutralized using zinc salts and their resulting properties. It will be appreciated by those skilled in the art that these ionomer blends are not technically ionomers until they have been neutralized.

Table 3 also specifies whether each example or comparative example was prepared using a 1-step or 2-step method. This corresponds to the above discussion of whether the first polymer composition and the second polymer composition were neutralized together or separately. In the 1-step preparation method, the first polymer composition and the second polymer composition were blended together first prior to neutralization. In the 2-step preparation method, the first polymer composition and the second polymer composition were neutralized first prior to being blended together first and then neutralized once blended.

TABLE 3
Ionomer Compositions Using Zinc Salts and Properties

| | Ex. | Ex. | Ex. | Ex. | Ex. | Comp. | Comp. | Comp. | Comp. | Ex. | Comp |
|---|---|---|---|---|---|---|---|---|---|---|---|
| | 2A | 2B | 2C | 2D | 2E | Ex. 2A | Ex. 2B | Ex. 2C | Ex. 2D | 2F¹ | Ex. 2E² |
| Polybond 1009 | 24.03 | 48.05 | 72.03 | 48.05 | 48.80 | 97.80 | 96.40 | — | — | 48.2 | 48.2 |
| DMDA 8007 | — | — | — | — | — | — | — | — | — | — | 50 |
| NUCREL ™ | 72.08 | 48.05 | 24.03 | — | 48.80 | — | — | 95.80 | — | 47.9 | — |
| 30707 | | | | | | | | | | | |
| NUCREL ™ | — | — | — | 48.05 | — | — | — | — | 95.60 | — | — |
| 0910 | | | | | | | | | | | |
| ZnO MB | 3.90 | 3.90 | 3.90 | 3.90 | 2.40 | 2.20 | 3.60 | 4.20 | 4.40 | 3.90 | 1.80 |
| Water | 2.00 | 2.00 | 2.00 | 2.00 | 2.00 | 2.00 | 2.00 | 2.00 | 2.00 | 2.00 | 2.00 |
| Preparation | 1-Step | 1-Step | 1-Step | 1-Step | 1-Step | 1-Step | 1-Step | 1-Step | 1-Step | 2-Step | 2-Step |
| Method | | | | | | | | | | | |
| Neutralization | 46.6 | 48.3 | 50.2 | 47.3 | 29.0 | 29.4 | 48.2 | 48.5 | 58.5 | 48.3 | 48.2 |
| (%) | | | | | | | | | | | |

Dynamic Mechanical Spectrometry (DMS) & DMTA Data

| | | | | | | | | | | | |
|---|---|---|---|---|---|---|---|---|---|---|---|
| Viscosity @ 0.1 | 11592 | 5734 | 4920 | 4808 | 3160 | 2796 | 3993 | 43648 | 9478 | 7186 | 1871 |
| s⁻¹, 190° C. | | | | | | | | | | | |
| Viscosity @ | 735 | 438 | 318 | 389 | 294 | 341 | 429 | 1880 | 773 | 533 | 358 |
| 100 s⁻¹, 190° C. | | | | | | | | | | | |
| Rheology Ratio | 15.8 | 13.1 | 15.5 | 12.4 | 10.7 | 8.2 | 9.3 | 23.2 | 12.3 | 13.5 | 5.2 |
| Phase Angle @ | 52 | 52 | 52 | 52 | 52 | 56 | 56 | 52 | 53 | 52 | 60 |
| G* = 20 kPa, | | | | | | | | | | | |
| 190° C. | | | | | | | | | | | |
| Thermal | 95 | 107 | 122 | 100 | 105 | 125 | 125 | 90 | 75 | 110 | 130 |
| Transition | | | | | | | | | | | |
| DMTA | | | | | | | | | | | |
| Temperature @ | | | | | | | | | | | |
| G′ = 10 MPa, 10 | | | | | | | | | | | |
| rad/s | | | | | | | | | | | |

¹Ex. 2F is a blend of equal parts of Comp. Ex. 2B and Comp. Ex. 2C. In Ex. 2F, Comp. Ex. 2B and Comp. Ex. 2C are both prepared (and neutralized) prior to blending together. The values in Table 3 correspond to the final composition of Ex. 2F.
²Comp. Ex. 2E is a blend of equal parts of Comp. Ex. 2B and DMDA 8007. Comp. Ex. 2E was prepared in the same manner as Ex. 2F (neutralization of the individual parts prior to blending).

Table 3 sets forth various embodiments of ionomer compositions having an enhanced temperature resistance. Examples 2A-2F provide embodiments of ionomer blends comprising AA grafted HDPE (Polybond 1009), and NUJCREL™ acid copolymers, or both, that are at least partially neutralized by a zinc salt. As can be seen in Table 3, the degree of neutralization for Examples 2A-2F varies between 29.0% and 50.2%. Each of Examples 2A-2F has an enhanced temperature resistance, as each example features a thermal transition DMTA temperature of greater than 90° C. Moreover, Examples 2A-2F each have a rheology ratio greater than 10.0 and a phase angle less than 57. Conversely, Comparative Examples 2A-2E, which do not include both the AA grafted HDPE and acid copolymer, or fail to achieve this combination of temperature resistance and rheology ratio and phase angle.

### Example 3—Ionomer Compositions with Enhanced Temperature Resistance Neutralized Using Sodium Salts

In Example 3, the ionomer compositions were prepared using the same method of Example 2. Compared to Example 2, in Example 3, a sodium salt was used for neutralization instead of a zinc salt. Table 4 provides the composition of various ionomer compositions neutralized using sodium salts and their resulting properties.

Similar to Table 3, Table 4 also specifies whether the examples and comparative examples were prepared using a 1-step or 2-step method.

TABLE 4
Ionomer Compositions Neutralized Using Sodium Salts and Properties

| | Ex. | Ex. | Ex. | Comp. | Comp. | Comp. | Ex. |
|---|---|---|---|---|---|---|---|
| | 3A | 3B | 3C | Ex. 3A | Ex. 3B | Ex. 3C | 3D² |
| Polybond 1009 | 23.98 | 47.95 | 71.93 | 96.20 | 93.50 | — | 48.2 |
| NUCREL ™ | 71.93 | 47.95 | 23.98 | — | — | 95.60 | 47.8 |
| 30707 | | | | | | | |
| NUCREL ™ | — | — | — | — | — | — | — |
| 0910 | | | | | | | |
| Na₂CO₃ MB | 4.10 | 4.10 | 4.10 | 3.80 | 6.50 | 4.40 | 4.10 |
| Water | 2.00 | 2.00 | 2.00 | 2.00 | 2.00 | 2.00 | 2.00 |
| Preparation | 1-Step | 1-Step | 1-Step | 1-Step | 1-Step | 1-Step | 2-Step |
| Method | | | | | | | |
| Neutralization | 46.3 | 48.0 | 49.9 | 48.0 | 83.0 | 48.0 | 48.0 |
| (%) | | | | | | | |

Dynamic Mechanical Spectrometry (DMS) & DMTA Data

| | | | | | | | |
|---|---|---|---|---|---|---|---|
| Viscosity @ 0.1 | 16417 | 11222 | 6194 | 4152 | 18689 | 32878 | 10487 |
| s⁻¹, 190° C. | | | | | | | |
| Viscosity @ 100 | 719 | 512 | 320 | 383 | 514 | 1558 | 499 |
| s⁻¹, 190° C. | | | | | | | |
| Rheology Ratio | 22.8 | 21.9 | 19.4 | 10.8 | 36.4 | 21.1 | 21.0 |
| Phase Angle @ | 48 | 50 | 51 | 54 | 44 | 53 | 48 |
| G* = 20 kPa, | | | | | | | |
| 190° C. | | | | | | | |
| Thermal | 94 | 101 | 120 | 125 | 125 | 90 | 106 |
| Transition | | | | | | | |
| DMTA | | | | | | | |
| Temperature @ | | | | | | | |
| G′ = 10 MPa, 10 | | | | | | | |
| rad/s | | | | | | | |

¹Ex. 3D is a blend of equal parts of Comp. Ex. 3A and Comp. Ex. 3C. In Ex. 3D, Comp. Ex. 3A and Comp. Ex. 3C are both prepared (and neutralized) prior to blending together. The values in Table 4 correspond to the final composition of Ex. 3D.

Table 4 sets forth various embodiments of ionomer compositions having an enhanced temperature resistance. As can be seen in Table 4, the degree of neutralization for Examples 3A-3D varies between 46.3% and 49.9%. Each of Examples 3A-3D has an enhanced temperature resistance, as each example features a thermal transition DMTA temperature of greater than 90° C. Moreover, Examples 3A-3D each have a rheology ratio greater than 10.0 and a phase angle less than 57. Conversely, Comparative Examples 3A-3C do not include both the AA grafted HDPE and acid copolymer.

### Example 4—Notched Izod Impact Strength Values of Various Embodiments from Examples 2 and 3

Table 5 provides notched Izod impact strength values for inventive and comparative examples from Examples 2 and 3.

TABLE 5
Notched Izod Impact Strength

| | | | | | | | | |
|---|---|---|---|---|---|---|---|---|
| Ex. | Ex. | Ex. | Comp. | Ex. | Ex. | Ex. | Comp. | Ex. |
| 2A | 2B | 2C | Ex. 2B | 3A | 3B | 3C | Ex. 3A | 3D |

Notched Izod Impact Strength

| | | | | | | | | | |
|---|---|---|---|---|---|---|---|---|---|
| At 23° C. (J/m) | NB¹ | NB¹ | 588 | 43.8 | NB¹ | NB¹ | 172 | 59.5 | NB¹ |
| At 0° C. (J/m) | NB¹ | NB¹ | 80.3 | 45.4 | NB¹ | 973 | 59 | 47.0 | NB¹ |
| At −23° C. (J/m) | NB¹ | 1009 | 56.2 | 43.7 | NB¹ | 98.7 | 51.7 | 46.4 | 322 |

¹NB refers to a Noticed Izod Impact Strength of greater than 1300 J/m.

As seen in Table 5, the examples in Table 5 exhibit much higher notched Izod impact strength than the comparative examples. In fact, many of the examples, to some degree, exhibit a notched Izod impact strength of greater than 1300 J/m. Conversely, the comparative example do not demonstrate a notched Izod impact strength of greater than 60.0. Thus, these inventive polymer blends not only demonstrate increased temperature resistance as shown above, but also exhibit improved impact strength.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A polymer blend comprising:
a first polymer composition comprising:
a polyolefin having a thermal transition temperature of at least 100° C. (defined as temperature below which the storage modulus is >10 MPa @ 10 rad/s measured using Dynamic Mechanical Thermal Analysis (DMTA)); and
graftable monomer comprising at least one acid or anhydride functional group grafted onto the polyolefin,
a second polymer composition comprising an E/X/Y ethylene interpolymer, wherein E is an ethylene monomer and comprises greater than 50 wt. % of the interpolymer, X is an α,β-unsaturated C₃-C₈ carboxylic acid and comprises greater than 0 to 25 wt. % of the ethylene interpolymer, and Y is an optional comonomer comprising C₁-C₈ alkyl acrylate.

2. The polymer blend of claim 1, wherein the polyolefin comprises ethylene based polymer or propylene based polymer.

3. The polymer blend of claim 2, wherein the ethylene based polymer comprises high-density polyethylene with a density greater than 0.940 g/cc.

4. The polymer blend of claim 1, wherein the graftable monomer comprises at least one of acrylic acid, methacrylic acid, or both grafted onto the polyolefin.

5. The polymer blend of claim 1, wherein the α,β-unsaturated C₃-C₈ carboxylic acid comprises acrylic acid, or methacrylic acid.

6. The polymer blend of claim 1, wherein the polyolefin comprises a melt index (I₂) of 0.5 to 60 g/10 mins, when measured according to ASTM D1238 (190° C./2.16 kg).

7. The polymer blend of claim 1, wherein the weight ratio of the first polymer composition to the second polymer composition is from 20/80 wt. % to 80/20 wt. %.

8. The polymer blend of claim 1, wherein the first polymer composition, the second polymer composition, or both comprise acrylic acid.

9. The polymer blend of claim 1, wherein the thermal transition temperature of the polyolefin is at least 125° C.

10. An ionomer composition comprising the polymer blend of claim 1, wherein the first polymer composition, the second polymer composition, or both are at least partially neutralized by metal salts.

11. The ionomer composition of claim 10, wherein from 15% to 90% of acid sites of the first polymer composition, the second polymer composition, or both are neutralized by the metal salts.

12. The ionomer composition of claim 10, wherein the metal salt comprises one or more salts of zinc, magnesium, lithium, aluminum, or sodium.

13. The ionomer composition of claim 10, wherein the ionomer composition has a rheology ratio greater than 10.0 (at a test temperature of 190° C.).

14. The ionomer composition of claim 10, wherein the ionomer composition has a phase angle less than 57° (at a test temperature of 190° C. and complex modulus of 20 kPa).

15. A method of making the ionomer composition of claim 10 comprising:
blending the first polymer composition and the second polymer composition; and
neutralizing the first polymer composition and the second polymer composition, wherein the first polymer composition, the second polymer composition, or both are neutralized by the metal salts before or after blending.
